(19) United States
(12) Patent Application Publication
(10) Pub. No.: US 2023/0125034 A1
(43) Pub. Date: Apr. 20, 2023

(54) CUSHION STRUCTURE AND MANUFACTURING METHOD THEREOF

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); SHIH-HSUN YEN, TAIPEI (TW)

(21) Appl. No.: 17/864,406

(22) Filed: Jul. 14, 2022

(30) Foreign Application Priority Data
Oct. 15, 2021 (TW) 110138287

(51) Int. Cl. B32B 25/04; B32B 5/02; B32B 5/20; B32B 5/24; B32B 25/20; B32B 7/10; B30B 15/06; B32B 27/34

(52) U.S. Cl. CPC B32B 25/045; B32B 5/022; B32B 5/024; B32B 5/20; B32B 5/245; B32B 25/042; B32B 25/20; B32B 7/10; B30B 15/061; B32B 27/34; B32B 2250/03; B32B 2250/40; B32B 2250/24; B32B 2255/02; B32B 2255/24; B32B 2255/102; B32B 2307/732; B32B 2307/734; B32B 2307/302; B32B 2266/14

(57) ABSTRACT

A cushion structure and a manufacturing method thereof are provided. The cushion structure includes an intermediate layer, two rubber layers, and two surface layers. The intermediate layer has a first surface and a second surface opposite to the first surface. The two rubber layers are respectively disposed on the first surface and the second surface of the intermediate layer. The two surface layers are respectively disposed on the two rubber layers. Each of the two rubber layers is formed from a rubber composition that includes a main rubber, a solvent, a conductive carbon material, and a foaming agent.

### CROSS-REFERENCE TO RELATED PATENT APPLICATION

This application claims the benefit of priority to Taiwan Patent Application No. 110138287, filed on Oct. 15, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a cushion structure, and more particularly to a multi-layered cushion structure for hot pressing of a copper clad laminate.

### BACKGROUND OF THE DISCLOSURE

When a copper clad laminate is hot-pressed, a cushion layer is required for improving thermal conductivity and uniformity of a pressed thickness. In the conventional hot pressing process, one or more kraft papers are usually used to form a cushion layer, and a certain quantity of kraft papers may be used at the same time to achieve a desired cushion effect. However, a kraft paper is only used once or twice due to its limited recovery property, and a frequent replacement of a kraft paper is required for maintaining a good cushion effect. As a result, a labor cost is increased, and a large consumption of kraft paper results in a larger number of trees being cut and an increased burden on the natural environment.

Therefore, how to develop a cushion material that has increased durability, good thermal conductivity, and uniformity of a pressed thickness at the same time, so as to replace one or more kraft papers, has become one of the important issues to be solved in the related industry.

### SUMMARY OF THE DISCLOSURE

In response to the above-referenced technical inadequacies, the present disclosure provides a cushion structure which has good thermal conductivity and uniformity and can be reused for multiple times. The present disclosure further provides a manufacturing method of the cushion structure.

In one aspect, the present disclosure provides a cushion structure for hot pressing of a copper clad laminate. The cushion structure includes an intermediate layer, two rubber layers, and two surface layers. The intermediate layer has a first surface and a second surface opposite to the first surface. The two rubber layers are respectively disposed on the first surface and the second surface of the intermediate layer. The two surface layers are respectively disposed on the two rubber layers. Each of the two rubber layers is formed from a rubber composition that includes a main rubber, a solvent, a conductive carbon material, and a foaming agent.

In certain embodiments, an added amount of the main rubber is from 90 phr to 100 phr, an added amount of the solvent is from 80 phr to 140 phr, an added amount of the conductive carbon material is from 3 phr to 8 phr, and an added amount of the foaming agent is from 0.1 phr to 5 phr.

In certain embodiments, the main rubber is a liquid silicone rubber having a molecular weight from 30,000 to 100,000, the solvent is xylene, and the conductive carbon material is carbon black.

In certain embodiments, the cushion structure further includes two surface treating layers. One of the two surface treating layers is disposed between one of the two rubber layers and one of the two surface layers, and another one of the two surface treating layers is disposed between another one of the two rubber layers and another one of the two surface layers.

In certain embodiments, each of the two surface treating layers contains a silane compound.

In certain embodiments, the intermediate layer is a non-woven fabric layer made from para-aramid fibers, and each of the two surface layers is a woven fabric layer made from meta-aramid fibers.

In certain embodiments, a thickness of the intermediate layer is from 2.2 mm to 2.3 mm.

In certain embodiments, a thickness of each of the two rubber layers is from 1 mm to 1.3 mm.

In certain embodiments, the cushion structure has a heat transfer rate of 11.5° C./min.

In certain embodiments, a thickness variation rate of each of the two rubber layers is greater than 20% under conditions including a temperature of 190° C. and a pressure per unit area of 25 kg/cm².

In another aspect, the present disclosure provides a manufacturing method of a cushion structure used for hot pressing of a copper clad laminate. The manufacturing method includes: providing an intermediate layer that has a first surface and a second surface opposite to the first surface; and bonding a first surface layer to the first surface of the intermediate layer via a first rubber layer and bonding a second surface layer to the second surface of the intermediate layer via a second rubber layer. Each of the first rubber layer and the second rubber layer is formed from a rubber composition that includes a main rubber, a solvent, a conductive carbon material, and a foaming agent.

In certain embodiments, an added amount of the main rubber is from 90 phr to 100 phr, an added amount of the solvent is from 80 phr to 140 phr, an added amount of the conductive carbon material is from 3 phr to 8 phr, and an added amount of the foaming agent is from 0.1 phr to 5 phr.

In certain embodiments, the main rubber is a liquid silicone rubber having a molecular weight from 30,000 to 100,000, the solvent is xylene, and the conductive carbon material is carbon black.

In certain embodiments, the step of bonding the first surface layer to the first surface of the intermediate layer via the first rubber layer includes: forming a first surface treating layer on the first surface layer; bonding the first surface layer to the first rubber layer via the first surface treating layer; and adhering the first rubber layer to the first surface of the intermediate layer. The step of bonding the second surface layer to the second surface of the intermediate layer via the second rubber layer includes: forming a second surface treating layer on the second surface layer; bonding the second surface layer to the second rubber layer via the second surface treating layer; and adhering the second rubber layer to the second surface of the intermediate layer.

In certain embodiments, the step of forming the first surface treating layer on the first surface layer includes: using a silane compound to treat a surface of the first surface layer. The step of forming the second surface treating layer on the second surface layer includes: using another silane compound to treat a surface of the second surface layer.

In certain embodiments, the intermediate layer is a non-woven fabric layer made from para-aramid fibers, and each of the first surface layer and the second surface layer is a woven fabric layer made from meta-aramid fibers.

In certain embodiments, a thickness of the intermediate layer is from 2.2 mm to 2.3 mm, and a thickness of each of the first rubber layer and the second rubber layer is from 1 mm to 1.3 mm.

In certain embodiments, the cushion structure has a heat transfer rate of 11.5° C./min.

In certain embodiments, a thickness variation rate of each of the first rubber layer and the second rubber layer is greater than 20% under conditions including a temperature of 190° C. and a pressure per unit area of 25 kg/cm².

One of the beneficial effects of the cushion structure and the manufacturing method provided by the present disclosure is that, by virtue of the cushion structure including an intermediate layer, two rubber layers, and two surface layers and each of the two rubber layers being formed from a rubber composition that includes a main rubber, a solvent, a conductive carbon material, and a foaming agent, the cushion structure can have good thermal conductivity and uniformity of a pressed thickness, and can be reused for multiple times.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a sectional view of a cushion structure according to a first embodiment of the present disclosure;

FIG. 2 is a sectional view of a cushion structure according to a second embodiment of the present disclosure;

FIG. 3 is a flowchart of a manufacturing method of the cushion structure of the present disclosure; and

FIG. 4 is a planar view of the cushion structure of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

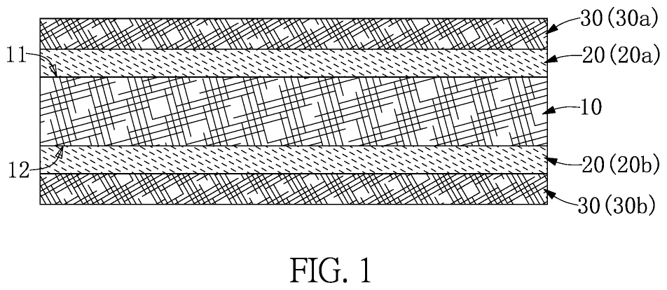

Referring to FIG. 1, a first embodiment of the present disclosure provides a cushion structure for hot pressing of a copper clad laminate. As shown in FIG. 1, the cushion structure is a five-layered structure and includes an intermediate layer 10, two rubber layers 20, and two surface layers 30. The intermediate layer 10 has a first surface 11 and a second surface 12 opposite to the first surface 11, and the two rubber layers 20 are respectively disposed on the first surface 11 and the second surface 12. The two surface layers 30 are respectively disposed on the two rubber layers 20. In practice, the intermediate layer 10 and the two surface layers 30 are made of aramid fibers (i.e., aromatic polyamide fibers). More specifically, the intermediate layer 10 is a non-woven fabric layer made from para-aramid fibers, and each of the two surface layers 30 is a woven fabric layer made from meta-aramid fibers.

In the present embodiment, each of the two rubber layers 20 is formed from a rubber composition. It is worth mentioning that the formula of the rubber composition can increase cushion and heat transfer effects of the cushion structure. The rubber composition mainly includes a main rubber, a solvent, a conductive carbon material, and a foaming agent. In practice, the main rubber can be a liquid silicone rubber having a molecular weight from 30,000 to 100,000. The solvent can be toluene, xylene, or a low molecular weight silicone oil. The conductive carbon material can be carbon black, graphite, boron nitride, or an alumina or stainless steel powder. It should be noted that those skilled in the art can adjust the formula of the rubber composition according to particular requirements, as long as the two rubber layers 20 can be provided with desired properties. For example, a thickness variation rate of each of the two rubber layers 20 is greater than 20% under conditions including a temperature of 190° C. and a pressure per unit area of 25 kg/cm². The above description is for exemplary purposes only and is not intended to limit the scope of the present disclosure.

More specifically, an added amount of the main rubber is from 90 phr to 100 phr, e.g., 91 phr, 92 phr, 93 phr, 94 phr, 95 phr, 96 phr, 97 phr, 98 phr, or 99 phr. An added amount of the solvent is from 80 phr to 140 phr, e.g., 85 phr, 90 phr, 95 phr, 100 phr, 105 phr, 110 phr, 115 phr, 120 phr, 125 phr, 130 phr, or 135 phr. An added amount of the conductive carbon material is from 3 phr to 8 phr, e.g., 3.5 phr, 4 phr, 4.5 phr, 5 phr, 5.5 phr, 6 phr, 6.5 phr, 7 phr, or 7.5 phr. An added amount of the foaming agent is from 0.1 phr to 5 phr, e.g., 0.5 phr, 1.0 phr, 1.5 phr, 2.0 phr, 2.5 phr, 3.0 phr, 3.5 phr, 4.0 phr, or 4.5 phr.

It can be understood from the above-mentioned rubber composition that each of the two rubber layers 20 is made of a liquid silicone rubber. Accordingly, one of the two rubber layers 20 is coated in a liquid state between the intermediate layer 10 and one of the two surface layers 30, such that the intermediate layer 10 and the one of the two surface layers 30 are combined together. However, when the liquid silicone rubber is coated on and pressed against the one of the two surface layers 30, the liquid silicone rubber may seep out of the one of the two surface layers 30 through pores and stick to a machine.

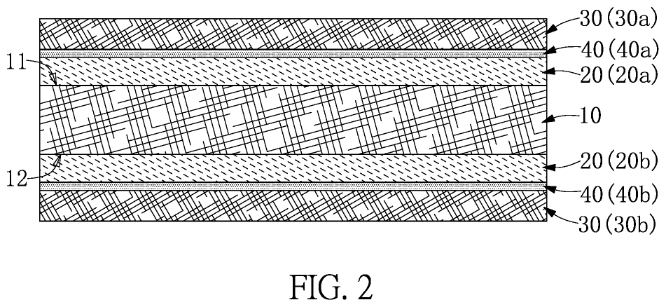

Reference is made to FIG. 2. In one preferable embodiment, the cushion structure of the present disclosure can further include two surface treating layers 40. One of the two surface treating layers 40 (e.g., an upper surface treating layer) is disposed between one of the two rubber layers 20 (e.g., an upper rubber layer) and one of the two surface layers 30 (e.g., an upper surface layer). Another one of the two surface treating layers 40 (e.g., a lower surface treating layer) is disposed between another one of the two rubber layers 20 (e.g., a lower rubber layer) and another one of the two surface layers 30 (e.g., a lower surface layer). Accordingly, a bonding strength between each of the two rubber layers 20 and the corresponding surface layer 30 can be increased. Furthermore, a liquid silicone rubber can be prevented from seeping out of one of the two surface layers 30 and sticking to a machine. More specifically, each of the two surface treating layers 40 is formed by treating a surface (e.g., an inner surface) of the corresponding surface layer 30 with a silane compound. Each of the two surface treating layers 40 can serve as a connection interface between a fabric layer made of aramid fibers and a silicone rubber layer, and can serve as a barrier layer to prevent a liquid silicone rubber from passing through pores of a fabric. The silane compound can be dimethylsiloxane, but is not limited thereto.

In certain embodiments, a thickness of the cushion structure of the present disclosure can be 5 mm. A thickness of the intermediate layer 10 is from 2.2 mm to 2.3 mm, e.g., 2.21 mm, 2.22 mm, 2.23 mm, 2.24 mm, 2.25 mm, 2.26 mm, 2.27 mm, 2.28 mm, or 2.29 mm. It should be noted that, if the thickness of the intermediate layer 10 is greater than 2.3 mm, a heat transfer effect of the cushion structure would be affected during a hot pressing process. If the thickness of the intermediate layer 10 is less than 2.2 mm, a sufficient supporting effect cannot be provided. In addition, a thickness of each of the two rubber layers 20 is from 1 mm to 1.3 mm, e.g., 1.0 mm, 1.1 mm, 1.2 mm, or 1.3 mm. It should be noted that, if the thickness of each of the two rubber layers 20 is greater than 1.3 mm, a heat transfer effect of the cushion structure would be affected during a hot pressing process. If the thickness of each of the two rubber layers 20 is less than 1.0 mm, a desired cushion effect cannot be provided.

A heat transfer coefficient (K) of the cushion structure of the present disclosure is calculated by the thermal conductivity equation: k=(Q/t)*L/(A*T); in which k represents a thermal conductivity, Q represents a heat flux, t represents a time, L represents a length, A represents an area, and T represents a temperature variation. The cushion structure of the present disclosure has a heat transfer rate of 11.5° C./min. Under the condition that a hot plate located at an upper position has a temperature of 190° C., a time required for the cushion structure of the present disclosure to heat a copper foil substrate located at a lower position from normal temperature to 145° C. is no more than 10 minutes.

### Second Embodiment

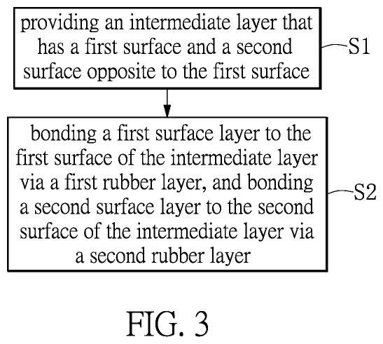

Referring to FIG. 3, which is to be read in conjunction with FIG. 1 and FIG. 2, a second embodiment of the present disclosure provides a manufacturing method of a cushion structure. The manufacturing method can be used for manufacturing a five-layered structure that at least includes: step S1, providing an intermediate layer that has a first surface and a second surface opposite to the first surface; and step S2, bonding a first surface layer to the first surface of the intermediate layer via a first rubber layer and bonding a second surface layer to the second surface of the intermediate layer via a second rubber layer. The cushion structure obtained by the manufacturing method of the present disclosure has a heat transfer rate of 11.5° C./min, such that it can provide a desired cushion effect required for a hot pressing process without affecting heat transfer.

More specifically, in step S2, a first surface treating layer 40a is formed on the first surface layer 30a (e.g., an upper surface layer), and the first surface layer 30a is bonded to a first rubber layer 20a (e.g., an upper rubber layer) via the first surface treating layer 40a. Afterwards, the first rubber layer 20a is adhered to the first surface 11 of the intermediate layer 10. Furthermore, a second surface treating layer 40b is formed on the second surface layer 30b (e.g., a lower surface layer), and the second surface layer 30b is bonded to a second rubber layer 20b (e.g., a lower rubber layer) via the second surface treating layer 40b. Afterwards, the second rubber layer 20b is adhered to the second surface 12 of the intermediate layer 10. The first surface treating layer 40a (or the second surface treating layer 40b) is formed by treating a surface of the first surface layer 30a (or the second surface layer 30b) with a silane compound. The silane compound can be dimethylsiloxane, but is not limited thereto.

In the present embodiment, the intermediate layer 10 is a non-woven fabric layer made from para-aramid fibers, and each of the two surface layers 30 is a woven fabric layer made from meta-aramid fibers. Each of the two rubber layers 20 is formed from a rubber composition, and the formula of the rubber composition can increase cushion and heat transfer effects of the cushion structure. The rubber composition mainly includes a main rubber, a solvent, a conductive carbon material, and a foaming agent. In practice, the main rubber can be a liquid silicone rubber having a molecular weight from 30,000 to 100,000. The solvent can be toluene, xylene, or a low molecular weight silicone oil. The conductive carbon material can be carbon black, graphite, boron nitride, or an alumina or stainless steel powder. It should be noted that those skilled in the art can adjust the formula of the rubber composition according to particular requirements, as long as the two rubber layers 20 can be provided with desired properties. For example, a thickness variation rate of each of the two rubber layers 20 is greater than 20% under conditions including a temperature of 190° C. and a pressure per unit area of 25 kg/cm². The above description is for exemplary purposes only and is not intended to limit the scope of the present disclosure.

More specifically, an added amount of the main rubber is from 90 phr to 100 phr, e.g., 91 phr, 92 phr, 93 phr, 94 phr, 95 phr, 96 phr, 97 phr, 98 phr, or 99 phr. An added amount of the solvent is from 80 phr to 140 phr, e.g., 85 phr, 90 phr, 95 phr, 100 phr, 105 phr, 110 phr, 115 phr, 120 phr, 125 phr, 130 phr, or 135 phr. An added amount of the conductive carbon material is from 3 phr to 8 phr, e.g., 3.5 phr, 4 phr, 4.5 phr, 5 phr, 5.5 phr, 6 phr, 6.5 phr, 7 phr, or 7.5 phr. An added amount of the foaming agent is from 0.1 phr to 5 phr, e.g., 0.5 phr, 1.0 phr, 1.5 phr, 2.0 phr, 2.5 phr, 3.0 phr, 3.5 phr, 4.0 phr, or 4.5 phr.

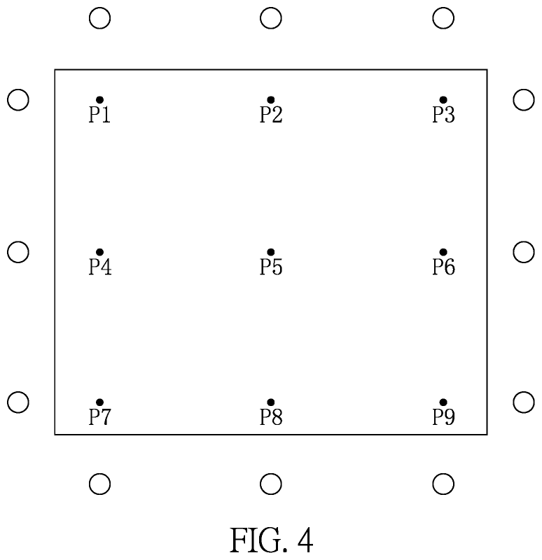

Referring to FIG. 4, a manner for calculating compression and recovery rates is described below. As shown in FIG. 4, nine points P1 to P9 are marked on a cushion structure to ensure that measurement positions before and after each compression are the same. A thickness of the cushion structure corresponding to each of the nine points P1 to P9 is measured to serve as a thickness before pressing (A). As shown by the circles in FIG. 4, a plurality of lead blocks are placed to surround the cushion structure at appropriate distances. Afterwards, in a simulated pressing process, upper and lower hot plates are heated to 190° C. to press the cushion structure by a pressing pressure of 25 kg/cm² for 30 minutes. After the simulated pressing process is completed for 30 minutes, a thickness of the cushion structure corresponding to each of the nine points P1 to P9 is measured to serve as a thickness after pressing (C), and a thickness of each of the lead blocks is measured to serve as a thickness when pressing (B).

The thickness before pressing (A), the thickness when pressing (B), and the thickness after pressing (C) are used to calculate compression and resilience rates by equations (1) and (2), and the compression and resilience rates are used to calculate a recovery rate by equation (3).

$$Compression rate ( \% ) = \frac{A - B}{A} \qquad ( 1 )$$

$$Resilience rate ( \% ) = \frac{C - B}{C} \qquad ( 2 )$$

$$Recovery rate ( \% ) = \frac{Resilience rate ( \% )}{Compression rate ( \% )} \qquad ( 3 )$$

The cushion structure of the present disclosure is compared with a kraft paper according to the above equations, and comparison results are listed in Table 1 below.

TABLE 1

| | Kraft | Examples | | | |
|---|---|---|---|---|---|
| | paper | 1 | 2 | 3 | 4 |
| Main rubber | — | 90 | 90 | 90 | 90 |
| Solvent | — | 80 | 80 | 80 | 80 |
| Conductive | — | 3 | 3 | 3 | 3 |
| carbon | | | | | |
| material | | | | | |
| Foaming | — | 0.1 | 0.25 | 1 | 2 |
| agent | | | | | |
| Compression | 20% | 22% to 25% | 24% to 27% | 19% to 21% | 16% to 18% |
| rate | | | | | |
| Recovery | 5%↓ | 90%↑ | 90%↑ | 90%↑ | 90%↑ |
| rate | | | | | |
| Number of | 1 to 2 | 300↑ | 300↑ | 300↑ | 300↑ |
| times of | | | | | |
| reuse | | | | | |

As shown in Table 1, although the kraft paper that serves as a cushion layer in a conventional copper clad laminate has a certain compression rate, a recovery rate of the kraft paper is less than 5% and a number of times of reuse is thus reduced. In comparison, the cushion structure of the present disclosure has a better compression rate and a recovery rate that reaches 90% or higher, such that a number of times of reuse can be increased to more than 300 times. Therefore, the cushion structure of the present disclosure has a cushion effect and a stable structure, and can be reused for multiple times for hot pressing copper clad laminates. Since the cushion effect is not affected, an increase of the number of times of reuse can reduce manpower required for frequently replacing a cushion layer and the risk during a replacing operation of the cushion layer, and also can reduce the waste of resources.

### Beneficial Effects of the Embodiments

In conclusion, in the cushion structure of the present disclosure, by virtue of the cushion structure including an intermediate layer, two rubber layers, and two surface layers and each of the two rubber layers being formed from a rubber composition that includes a main rubber, a solvent, a conductive carbon material, and a foaming agent, the cushion structure can have good thermal conductivity and uniformity of a pressed thickness, and can be reused for multiple times. Furthermore, in the cushion structure of the present disclosure, by virtue of each of the two surface layers being treated with a silane compound to form a surface treating layer thereon, a liquid silicone rubber can be prevented from seeping out of one of the two surface layers through pores and sticking to a machine.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A cushion structure for hot pressing of a copper clad laminate, comprising:
an intermediate layer having a first surface and a second surface opposite to the first surface;
two rubber layers respectively disposed on the first surface and the second surface of the intermediate layer; and
two surface layers respectively disposed on the two rubber layers;
wherein each of the two rubber layers is formed from a rubber composition that includes a main rubber, a solvent, a conductive carbon material, and a foaming agent.

2. The cushion structure according to claim 1, wherein an added amount of the main rubber is from 90 phr to 100 phr, an added amount of the solvent is from 80 phr to 140 phr, an added amount of the conductive carbon material is from 3 phr to 8 phr, and an added amount of the foaming agent is from 0.1 phr to 5 phr.

3. The cushion structure according to claim 2, wherein the main rubber is a liquid silicone rubber having a molecular weight from 30,000 to 100,000, the solvent is xylene, and the conductive carbon material is carbon black.

4. The cushion structure according to claim 1, further comprising two surface treating layers, wherein one of the two surface treating layers is disposed between one of the two rubber layers and one of the two surface layers, and another one of the two surface treating layers is disposed between another one of the two rubber layers and another one of the two surface layers.

5. The cushion structure according to claim 4, wherein each of the two surface treating layers contains a silane compound.

6. The cushion structure according to claim 1, wherein the intermediate layer is a non-woven fabric layer made from para-aramid fibers, and each of the two surface layers is a woven fabric layer made from meta-aramid fibers.

7. The cushion structure according to claim 1, wherein a thickness of the intermediate layer is from 2.2 mm to 2.3 mm.

8. The cushion structure according to claim 1, wherein a thickness of each of the two rubber layers is from 1 mm to 1.3 mm.

9. The cushion structure according to claim 1, wherein the cushion structure has a heat transfer rate of 11.5° C./min.

10. The cushion structure according to claim 1, wherein a thickness variation rate of each of the two rubber layers is greater than 20% under conditions including a temperature of 190° C. and a pressure per unit area of 25 kg/cm².

11. A manufacturing method of a cushion structure used for hot pressing of a copper clad laminate, comprising:
providing an intermediate layer that has a first surface and a second surface opposite to the first surface; and
bonding a first surface layer to the first surface of the intermediate layer via a first rubber layer, and bonding a second surface layer to the second surface of the intermediate layer via a second rubber layer;
wherein each of the first rubber layer and the second rubber layer is formed from a rubber composition that includes a main rubber, a solvent, a conductive carbon material, and a foaming agent.

12. The manufacturing method according to claim 11, wherein an added amount of the main rubber is from 90 phr to 100 phr, an added amount of the solvent is from 80 phr to 140 phr, an added amount of the conductive carbon material is from 3 phr to 8 phr, and an added amount of the foaming agent is from 0.1 phr to 5 phr.

13. The manufacturing method according to claim 12, wherein the main rubber is a liquid silicone rubber having a molecular weight from 30,000 to 100,000, the solvent is xylene, and the conductive carbon material is carbon black.

14. The manufacturing method according to claim 11, wherein the step of bonding the first surface layer to the first surface of the intermediate layer via the first rubber layer includes: forming a first surface treating layer on the first surface layer; bonding the first surface layer to the first rubber layer via the first surface treating layer; and adhering the first rubber layer to the first surface of the intermediate layer; wherein the step of bonding the second surface layer to the second surface of the intermediate layer via the second rubber layer includes: forming a second surface treating layer on the second surface layer; bonding the second surface layer to the second rubber layer via the second surface treating layer; and adhering the second rubber layer to the second surface of the intermediate layer.

15. The manufacturing method according to claim 14, wherein the step of forming the first surface treating layer on the first surface layer includes: using a silane compound to treat a surface of the first surface layer; and the step of forming the second surface treating layer on the second surface layer includes: using another silane compound to treat a surface of the second surface layer.

16. The manufacturing method according to claim 11, wherein the intermediate layer is a non-woven fabric layer made from para-aramid fibers, and each of the first surface layer and the second surface layer is a woven fabric layer made from meta-aramid fibers.

17. The manufacturing method according to claim 11, wherein a thickness of the intermediate layer is from 2.2 mm to 2.3 mm, and a thickness of each of the first rubber layer and the second rubber layer is from 1 mm to 1.3 mm.

18. The manufacturing method according to claim 11, wherein the cushion structure has a heat transfer rate of 11.5° C./min.

19. The manufacturing method according to claim 11, wherein a thickness variation rate of each of the first rubber layer and the second rubber layer is greater than 20% under conditions including a temperature of 190° C. and a pressure per unit area of 25 kg/cm².
